(19) United States
(12) Patent Application Publication
(10) Pub. No.: US 2008/0222517 A1
(43) Pub. Date: Sep. 11, 2008

(54) Applying Patterns to XSD for Extending Functionality to Both XML and non-XML Data Data Structures

(75) Inventors: Fakher Halim, Villa Park, IL (US); Mushtaq H. Merchant, Deer Park, IL (US)

Correspondence Address: MICHAEL J. BUCHENHORNER, 8540 S.W. 83 STREET, MIAMI, FL, 33143, US

(73) Assignee: Task Performance Group, Inc., Des Plaines, IL (US)

(21) Appl. No.: 11/684,196

(22) Filed: Mar. 9, 2007

(51) Int. Cl. G06F 17/00

(52) U.S. Cl. 715/236; 715/234; 715/239

(57) ABSTRACT

A system and method for transforming an input document in a first format into an output document in a second format extends XSD to work with non-XML data structures and data formats such as EBCDIC through the application of specialized patterns embedded in an XSD document. A communication adapter interprets the patterns and applies them to convert a flat file into an XML document (and vice versa) which can be viewed in a web browser. The system includes: a communication adapter for translating an XML source file into the output document; a network access translation firewall; a load balancer; a web portal; an offline processor for creating ffXSD and XSLT documents; and an input/output subsystem for interacting with an end user, the subsystem comprising a network interface.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of web browsing software and more particularly relates to the field of XML software.

### BACKGROUND OF THE INVENTION

XML(eXtensible Markup Language) was developed as a toolkit for markup languages. It can be thought of as an information container. From “Learning XML” by Erik T. Ray, 2^{nd} Edition, O'Reilly and Associates, Inc.: “Information is a valuable asset, but its value depends on its longevity, flexibility, and accessibility. Can you get to your data easily? Is it clearly labeled? Can you repackage it in any form you need? Can you provide it to others without a hassle? These are the questions that the Extensible Markup Language (XML) was designed to answer.” Since the introduction of XML in the late nineties, many standards, rules, and markup tools have been developed to take advantage of its adaptability.

One such example is XSD (eXtensible Schema Definition). XSD is designed to work with the XML data format. In particular, XSD is designed to work with XML data on PC (personal computer) data formats such as ASCII, Unicode, and UTF-16, to name a few. XSD is limited in that it cannot work with non-XML data structures and data formats such as EBCDIC (Extended Binary Coded Decimal Interchange Code).

Another outgrowth of XML is XSLT (eXtensible Stylesheet Language Transformation), which was produced as a language for transforming XML documents into other XML documents. XSLT uses processing instructions with an ‘xsl:’ namespace. However, XSLT is restricted to XML in: XML out, meaning that it relies on a document to be in the XML format before it can perform its processing.

Initially, software requirements necessitated special software for mainframe format, e.g. those generated by COBOL programs. Programmers would write code the old fashioned way, statement by statement to read records and fields hard-coded in procedure/function. Later, this was parameterized to have one XML layout modeling the flat file layout. Although this has worked quite well for some time, two specifications had to be maintained; one for non-XML; and yet another for XML structure.

The problem is that mainframes such as the IBM mainframes and IBM AS/400 (iSeries) computer systems continue to rely on non-XML data formats. At the other end of the computer spectrum, XSD is increasingly popular for use with personal computers.

There is a need for a system and method that overcomes the shortcomings of the prior art.

### SUMMARY OF THE INVENTION

Briefly, according to an embodiment of the invention, a method for transforming at least one non-XML file into an XML file includes steps or acts of: receiving the at least one non-XML file, wherein the at least one non-XML file includes records, fields, and file attributes; creating an ffXSD document from the at least one non-XML file; creating an XSLT document from the ffXSD document using an end user's business process; parsing the at least one non-XML file; mapping the records and fields to XML nodes; converting the at least one non-XML file into an XML source file, using the ffXSD; converting the XML source file to the XML file by applying XML tags from XSLT to the XML source file, and using ffXSD, such that the XML file corresponds to an end user's business process and the XML file is viewable via a web browser; and transmitting the XML file to the end user.

According to another embodiment of the present invention, a method for transforming an XML file into at least one non-XML file includes steps or acts of: receiving the XML file, wherein the XML file comprises XML nodes; parsing the XML file; creating an ffXSD document from the XML file by defining XML elements; creating an XSLT document from the ffXSD document using an end user's business process; mapping the XML nodes to records and fields; converting the ffxSD document into the non-XML file; and transmitting the at least one non-XML file to the end user.

According to an embodiment of the present invention, a system for transforming an input document in a first format into an output document in a second format includes: a communication adapter for translating an XML source file into the output document; a network access translation firewall; a load balancer; a web portal; an offline processor for creating ffXSD and XSLT documents; and an input/output subsystem for interacting with an end user, the subsystem comprising a network interface.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system according to an embodiment of the invention;

FIG. 2 is a simplified illustration of the components of the communication adapter, according to an embodiment of the present invention;

FIG. 3 is a flowchart of the method for translating documents, according to an embodiment of the present invention;

FIG. 4 is a simplified block diagram depicting optional components of the communication adapter, according to an embodiment of the present invention;

FIG. 5 is a flowchart illustrating flat file parsing for file/record level attributes, according to an embodiment of the present invention;

FIG. 6 is a flowchart illustrating flat file parsing for field level attributes, according to an embodiment of the present invention;

FIG. 7 is a flowchart illustrating flat file parsing for grouping/XML rendering, according to an embodiment of the present invention;

FIG. 8 shows a sample of a raw input file to be processed by a method according to an embodiment of the present invention;

FIG. 9 shows the ffXSD Schema for parsing the file of FIG. 8, according to an embodiment of the present invention;

FIG. 10 shows the file level attributes for the ffXSD Schema of FIG. 9, according to an embodiment of the present invention;

FIG. 11 shows the input file of FIG. 8 after conversion to an XML file, according to an embodiment of the present invention;

FIG. 12 shows the address field of the schema of FIG. 9, according to an embodiment of the present invention;

FIG. 13 shows the parsing for the address field of FIG. 12, according to an embodiment of the present invention;

FIG. 14 is a flowchart illustrating the process of transforming an XML document into a non-XML file, according to an embodiment of the present invention; and

FIG. 15 is a graphical illustration of the O-Exchange-MCE component processing, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a low-cost, pay-as-you-go system and method for extending XSD to work with non-XML data structures and data formats such as EBCDIC. Input files in EDI, flat file or XML formats are converted into XML source code and then generated as output files in either flat file, EDI, or XML.

The output files are viewable through a web browser. The XML output can then be transmitted to other in-house back-end systems to allow enterprises to collaborate more efficiently. We refer to this system and method as O-XML.

### Overview of System.

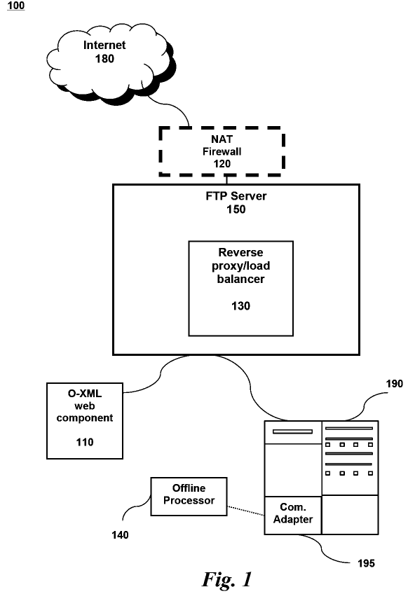

Referring now in specific detail to the drawings, and particularly FIG. 1, there is illustrated a high-level block diagram of the system 100 according to an embodiment of the present invention.

The O-XML web component 110 is hosted behind a network access translation firewall 120, and also has a front-end Linux-based reverse proxy/load balancer 130 that acts as the interface between a network 180 (in this case the Internet) and the FTP server 150. The Load Balancer 130 performs SSL (Secure Sockets Layer) wrapping for services and also features an SSL server certificate to verify its connection to the proprietary O-XML server 190. This server 190 contains the Communication Adapter 195 which performs the transformations. The Communication Adapter 195 is a representation of various adapters (also known as translators, parser, or mappers) which perform the transformations. Two of these adapters are the Flat File Adapter and the XML Adapter. The XSD and XSLT documents are created offline and then sent to the Adapter 195 for processing. The Load Balancer 130 also performs HTTP filtering of requests for selected parts of the application—only these are forwarded to the FTP server 150—all other requests are discarded. Offline Processors 140 create the XSD and XSLT documents.

All connections to the FTP server 150 are logged. A Linux-based system is used for monitoring the status of servers and the services running on them, and reports status to administrators should any of these services fail. Additionally, to implement the pay-as-you-go feature, transactions are recorded and a cost is allocated to each transaction, for billing purposes.

The server 190, consistent with an embodiment of the present invention, may represent any type of computer, information processing system or other programmable electronic device, including a client computer, a server computer, a portable computer, an embedded controller, a personal digital assistant, and so on. The computer system 190 may be a stand-alone device or networked into a larger system. The system 190 could include a number of operators and peripheral devices including a processor, a memory, and an input/output (I/O) subsystem. The processor may be a general or special purpose microprocessor operating under control of computer program instructions executed from a memory. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. RAM may be embodied in one or more memory chips. The memory may be partitioned or otherwise mapped to reflect the boundaries of the various memory subcomponents. The memory represents either a random-access memory or mass storage. It can be volatile or non-volatile. The system 190 can also comprise a magnetic media mass storage device such as a hard disk drive.

The I/O subsystem may comprise various end user interfaces such as a display, a keyboards, and a mouse. The I/O subsystem may further comprise a connection to a network such as a local-area network (LAN) or wide-area network (WAN) such as the Internet. Processor and memory components are physically interconnected using conventional bus architecture. What has been shown and discussed is a highly-simplified depiction of a programmable computer apparatus. Those skilled in the art will appreciate that a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include ROMs, DVD-ROMs, and transmission-type media, such as digital and analog communication links, wired or wireless communications links using transmission forms, such as, for example, radio frequency and light wave transmissions. The signal bearing media make take the form of coded formats that are decoded for use in a particular data processing system.

Presently, O-XML works with Linux systems and IBM mainframes including the AS/400 (iSeries) based ERP or legacy systems while it resides on a Windows-based system interacting with ERP or legacy systems.

O-XML transforms files by applying specialized patterns to extend XSD to work with non-XML data structures and data formats such as EBCDIC (Extended Binary Coded Decimal Interchange Code). We refer to this extended XSD as flat file XSD (ffXSD). The idea evolved out of the necessity of converting business data formats into an XML map-able format. XSD is ideal for working with files, but its reach was limited to XML; therefore ffXSD was created to extend XSD's functionality to non-XML data formats.

### XSD Background.

First we will provide some background on XSD before describing the functionality of ffXSD. XSD provides the syntax and defines a way in which elements and attributes can be represented in an XML document. It also prescribes that the given XML document should be of a specific format and specific data type. As stated earlier, XSD is eXtensible Schema Definition. A schema defines the structure of a document. A structure of an XML document can be defined as follows: Document Type Definition (DTDs); XML Schema Definition (XSD); and XML Data Reduced (XDR)—proprietary to Microsoft Technology.

The benefits of XSD are many, but the ones which most apply to this discussion are: 1) the ability to define your own data type from the existing data type and 2) XSD schema provides the ability to specify data types for both elements and attributes. Here is an example of XSD defining how a social security number should be presented in an XML document, using the “pattern” constraint:

```
<xsd:simpleType name=“ssnumber”>
  <xsd:restriction base=“xsd:string”>
    <xsd:length value=“11”>
    <xsd:pattern value=“\d{3}\-\d{2}\-\d{4}”/>
  </xsd:restriction>
</xsd:simpleType>
```

To ensure that the social security number appears in the “123-11-1234” format, the pattern is specified in the following format: <xsd:pattern value=“\d{3}\-\d{2}\-\d{4}”/>. The pattern value specifies that there should be three characters at the start (\d{3}), followed by two characters after the first “-” and finally followed by four characters after the second “-”.

### O-XML General.

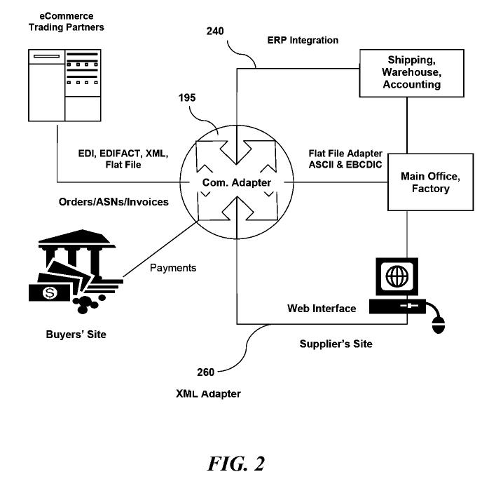

Referring to FIG. 2 there is shown a graphical representation of the functions of the Communication Adapter 195. The Communication Adapter 195 may be hosted in-house or at a central location. The two main components of the Communication Adapter 195 are the XML Adapter 260 and the Flat File Adapter 240. It should be understood that the Communication Adapter 195 represents software and/or firmware as part of larger data processing system.

O-XML exploits the power of XML to increase efficiency within an organization by allowing internal support staff to view electronic documents via a web browser even if these documents were not originally produced as browser-viewable documents. These easy-to-read electronic documents present themselves as visual replicas of their paper-based counterparts. This in turn permits staff such as accounting personnel to more quickly identify, act on and resolve otherwise time-consuming electronic transaction matters. In addition, these documents can be forwarded via e-mail to other staff members and opened by their desktop browser client to perform the following tasks: a) transmit orders from any time zone; b) obtain immediate order receipt notification; and c) track order status on-line.

With O-XML, a company can exchange purchase orders, invoices and shipment notices, achieve enterprise-wide data integration, and automate mission-critical, enterprise-wide business processes to: a) Reduce time to market; b) Shorten lead times; c) Lower operational costs by eliminating manual ops; d) Increase customer satisfaction; and e) Eliminate the potential for errors. In instances involving a large number of EDI/EDIFACT transactions, the savings associated with eliminating data entry easily offsets the cost of an EDI system, and also improves the efficiency and accuracy of back-end office functions. O-XML is based on the W3C-approved standards for XML development.

The key aspects of O-XML are: a) defining and using pattern recognition techniques within the XSD protocol; and b) transforming XML and non-XML formats in either direction. The key advantage of O-XML is that it extends the sophisticated XSD technology available in the PC realm to the legacy system and ERP (Enterprise Resource Planning) and mainframe world.

O-XML unifies all XML and non-XML, including EBCDIC and binary encodings, within a single standard XSD file formatted by regular XSD editing tools. Using a method according to an embodiment of the present invention, we extend new technologies to integrate any non-XML data formats including those used by IBM mainframes and IBM AS/400 (iSeries) computer systems into XML-type documents viewable through a web browser. The method is implemented as software that makes it possible for XML technologies to be extended to IBM data formats such as EBCDIC, which are still widely used today.

There are two processes required to make it work: 1) the application of specialized “patterns” to the already existing pattern constraints within XSD; and 2) specific writing of communication adapters (software program code) to interpret those specialized patterns and achieve data transformation from XML to non-XML ERP and legacy systems on IBM mainframe, AS/400 (iSeries) and flat file computer systems. Conversely, non-XML documents can be transformed into XML documents. The Communication Adapter 195 extracts directives from the <xsd:pattern/> and <xsd:attribute/> XSD constraints and performs their transformation functions accordingly. Note that the <xsd:pattern> and <xsd:attribute> constraints are already part of the XSD structure; therefore the XSD structure remains the same, thus simplifying the process.

### O-XML Web Component 110.

The O-XML Web Component 110 is an EDI-XML Web Portal that allows small suppliers to have the ability to conduct business using EDI without requiring in-house EDI expertise or expensive hardware. It is an outsourced feature for all EDI needs, allowing suppliers to concentrate on their core competency. It accepts inbound EDI from trading partners and translates them into XML and makes them available for processing using the Internet. By using a web portal purchase orders and ASNs, invoices, and so forth can be processed much more rapidly. This can reduce data entry by 70% as per testimonials provided by clients. The Web Component 110 may be used with or without the Communication Adapter 195.

### Communication Adapter 195.

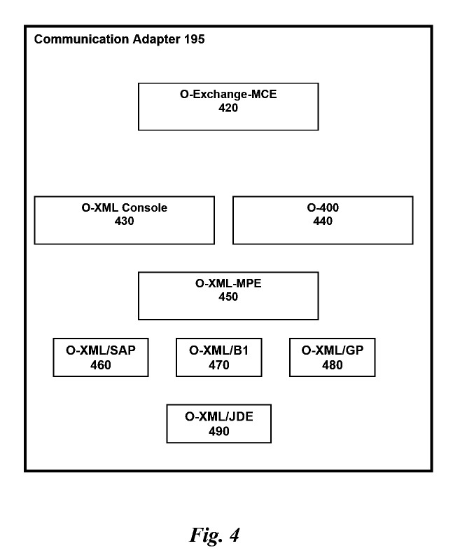

The Communication Adapter 195 is the key component of the O-XML system. It performs the transformations. The two major components are the Flat File Adapter 240, for transforming flat files to XML and vice versa; and the XML Adapter 260 for making XML and non-XML data available for processing through a web browser. The Adapter 195 can be optionally configured with the following modular components, as shown in FIG. 4:

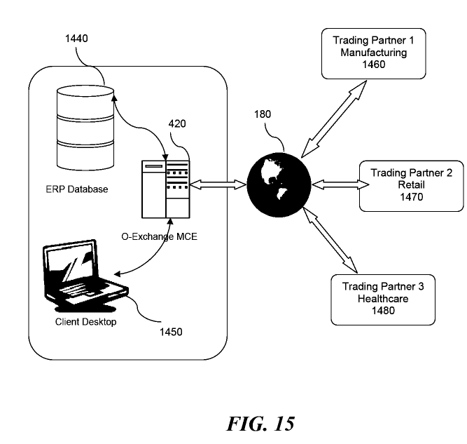

O-Exchange-MCE (Enterprise EDI-XML Web Portal)—O-Exchange-MCE 420 allows midsize to large trading partners to have the ability to send and receive EDI and non-EDI data between their suppliers. It is a software product for integrating proprietary business software with the XML source code to create an XML document that adheres to a client's particular mandate. It accepts inbound EDI and non-EDI generated from trading partners back-end systems, translates EDI and non-EDI into XML and makes it available for processing using the Internet. By using the Internet instead of a private communication network such as VAN (Value Added Network), trading partners can conduct unlimited EDI and non-EDI processing with their suppliers, saving tremendous VAN cost in processing POs, ASNs, Invoices, and so forth. FIG. 15 graphically depicts the processing performed by the O-Exchange-MCE 420. FIG. 15 shows three trading partners (Manufacturing 1460, Retail 1470, and Healthcare 1480), but the number of trading partners will vary according to the application. The central communication link is the Internet 180. From the Client Site, a user can access EDI data on his/her computer 1450 over a web interface as provided by the O-Exchange-MCE 420 component. It uses O-XML to synchronize data with ERP 1440.

O-XML-Console (Enterprise Application Integrator EAI)—O-XML-Console 430 allows front-end EDI process to marshal data to back-end ERP (Enterprise Resource Planning) and legacy systems thereby creating collaboration between systems. It accepts inbound EDI from trading partners, translates into XML and makes it available for clients in a GUI application. Client's business rules are applied to create output for further processing by back-end ERP systems such as JD Edwards®, SAP®, PeopleSoft®, Oracle®, Progress® etc. Outbound EDI data can be accepted via FTP in flat-file, XML or SQL etc., formats and converted to EDI and sent to the client's trading partner. Investment in the existing ERP and legacy systems remains intact.

O-400—Designed for IBM® AS400 (iSeries) users, O-400 440 accepts EDI/EDIFACT input on a flat-file, applies the client's business rules, creates XML and flat-file output for further processing by back-end ERP systems such as JD Edwards®, SAP®, PeopleSoft®, Oracle®, Progress® etc.

O-XML-MPE (Mainframe EDI translator Replacement)—O-XML-MPE 450 is a mainframe EDI translator replacement on PC based Servers. It has automation engine designed for high volume and high performance systems. It performs the same translation functions as mainframe, saving 90% of mainframe elapse time. Inbound EDI data is converted into XML and delivered in variety of required formats such as flat-file, SQL, XML and others.

O-XML/SAP 460—This is a seamless integration of SAP® IDoc based products such as R/3, mySAP, and A1 (All in One) with EDI and XML. O-XML SAP 460 is primarily designed for SAP IDoc integration with EDI, EDIFACT and XML. It provides seamless integration between B2B eCommerce Systems such as X12 EDI, UN/EDIFACT, XML, flat file; and backend SAP ERP systems, such as Sales and Distribution (SD) and Materials Management (MM); using IDoc.

O-XML/B1 470—O-XML B1 470 is primarily designed for SAP® Business One Integration with EDI and XML. It provides seamless integration between front-end B2B eCommerce and backend SAP Business One. O-XML B1 470 is certified by SAP®.

O-XML/GP 480—O-XML GP 480 is primarily designed for Microsoft Dynamics GP® integration with EDI and XML. It provides seamless integration between front-end B2B eCommerce and backend Microsoft Dynamics GP.

O-XML/JDE 490—B2B eCommerce is the heart of doing business between company buyers and suppliers. Due to the high volume of transactions midsize to large companies use Oracle JD Edwards ERP on either iSeries (AS400) or Windows based EDI translator. O-XML/JDE 490 provides a seamless integration between Oracle JDE and EDI and XML.

### Applying Specialized Patterns to Non-XML Documents.

O-XML achieves its “interpretation” by employing a novel method of utilizing XSD as a carrier of non-XML flat file structure definitions. These definitions are applied as specialized “patterns” as illustrated below. The specialized patterns are inserted into the existing pattern constraints within XSD. They are embedded within the XSD document in the “xs:pattern” constraint and follow the XSD syntax.

Table 1 provides an example, in text format, showing a specialized pattern “.*(AN|1)* applied to XSD. This particular pattern instructs the O-XML adapter to process the string defined as “OrderNumber” as shown in Table 2.

TABLE 1
ffXSD Text Format with Pattern Applied.

```
    </xs:complextype>
  </xs:element>
  <xs:attributeGroup name=”Header”>
    <xs:attribute name=”OrderNumber” use=”required”>
      <xs:simpleType>
          <xs:restriction base=”xs:string”>
              <xs:maxLength value=”22”/>
            <xs:pattern value=”.*(AN|1)*”/>
          </xs:restriction>
      </xs:simpleType>
    </xs:attribute>
  </xs:attributeGroup>
</xs:element>
```

TABLE 2
Parsing of Pattern “.*(AN|1)*”

| . | * | AN | \| | 1 | * |
|---|---|---|---|---|---|
| Any | Repeat | Alpha- | Separator | Starting | Pattern |
| character | preceding | numeric | pipe | position of | terminator |
| | character | value | | this filed in | |
| | | | | a record | |

The above text format XSD containing an ffXSD pattern is further processed through the O-XML mapping process to create XML tags which allow the document to be viewable in a web browser. The resulting document is an XML document, conforming to the XML syntax. ffXSD enhancements enable one master specification in a single XSD file to cover both XML and non XML domains. This master specification contains all of the information necessary to process the file in whatever format the file was originally written.

Flat files are composed of records and fields (the records contain fields). O-XML converts records into tagged XML nodes. Optional attributes of XSD which do not fall into the category of either a record or a field are treated as special directives for the O-XML Adapters. These optional attributes, such as “delimeter,” specify how the file should be handled. For record fields, whatever can be presently recognized by XML and XSD is processed in the standard way. The XSD “xs:pattern,” which contains regular expressions, is extended for element definitions. The Adapter 195 parses the input file to retrieve record level definitions in a “FlatFile” attribute; and also retrieves the special, non-XML, treatment required by non-XML fields (e.g. Binary, EBCDIC; encodings) in the “xs:pattern” element of the corresponding XSD attribute.

To use O-XML various patterns are applied to XSD and then the O-XML Communication Adapter 195 recognizes and interprets the applied patterns to extend data formats, e.g. from ASCII (American Standard Code for Information Interchange) on the PC platform to an IBM mainframe and EBCDIC data format, as an example.

### O-XML Process.

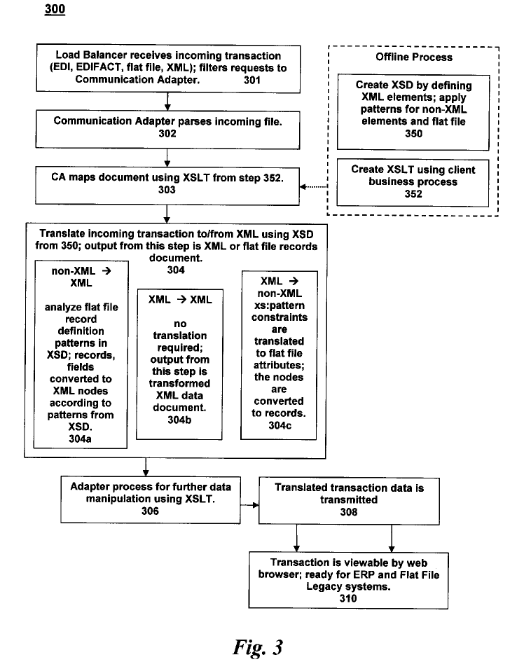

Referring to FIG. 3, there is shown a flow chart 300 illustrating a high-level view of the O-XML processing method according to an embodiment of the invention. The method begins at step 301 wherein incoming transactions such as purchase orders are received by the Load Balancer 130. These incoming transactions may be in EDI, EDIFACT, XML, or flat file format. The Load Balancer 130 filters these requests and routes the relevant ones to the Communication Adapter 195. In step 302, the Communication Adapter 195 parses the incoming file.

Concurrently, in step 350 an offline processor 140 creates an XSD document from the incoming file by defining the XML elements and applying patterns for non-XML elements and flat files. The offline process is a manual process using software tools such as xmlSpy to create the XSD and StylusStudio to create the XSLT. After the XSD document is created in step 350, an XSLT stylesheet is created using the client's own business process in step 352.

The offline process of steps 350 and 352 generates two output documents: an XSD document and an XSLT document. These two documents are sent to the Communication Adapter 195. Using the XSLT document created in step 352, in step 303 the Communication Adapter 195 maps the incoming document to the XSLT document. An XML or flat file records document is the resulting output from this step. The translation begins with parsing the document, and noting each element. Step 304 is further broken down as follows: step 304a—if the input file is a non-XML file, then the records are converted to XML nodes. Whatever can be presently recognized by XML and XSD is processed in the standard way (for example, name fields remain the same). The Adapter 195 retrieves the record level and file level definitions from the XSD created in step 350; analyzes them and creates XML nodes. A further O-XML mapping process creates XML tags from the XML source code output from step 303.

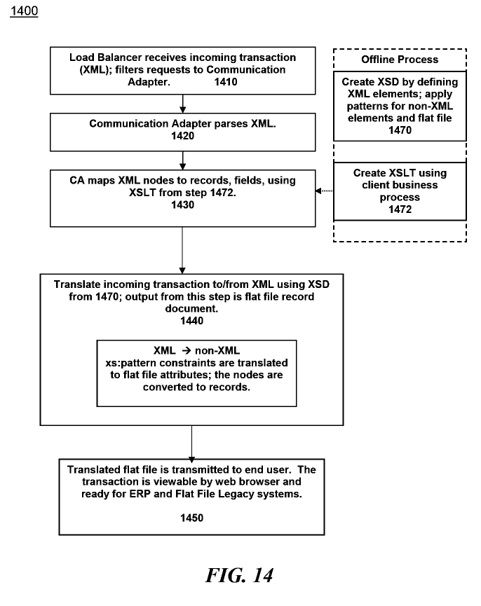

Step 304b—if the input file is an XML file and the output is also XML, then XML data is merely transposed to client requirements data validation with XSD. Step 304c—if the input file is an XML file and the output is a flat file, then the “xs:pattern” constraints are translated to flat file attributes and the nodes are converted to records and fields by the Flat File Adapter 240. The output from this step is also an XML document viewable via a web browser with a counterpart flat file with the nodes converted to records and flat files. The flowchart of FIG. 14 shows this process.

In step 306 the input file and the output from step 304 are both further processed by the Adapter 195 for further data manipulation according to whichever specified format is required, such as EDI /EDIFACT, XML, flat-file, to allow easy integration with most ERP and legacy system applications. In step 308 translated transaction data is transmitted to the client in the format required by the client. Lastly, in step 310 the translated data transmitted to the client can be viewable by a web browser; and, depending on the output specifications, can be processed by a flat file legacy system. This entire transformation process, excluding the offline processing, is proactively monitored and managed by technical experts and performed by the Communication Adapter 195.

### Offline Processor 140.

The offline processing is performed by software developers. For the XSD offline process, the XSDs are created by software developers using a proprietary software utility specifically for XML, such as xmlSpy. Patterns are created and applied to extend the functionality of XSD for flat file processing. These patterns are necessary to describe non-XML data structures such as flat file, records and data types. The patterns are inserted into the XSD document and then they become part of the XSD document, producing ffXSD. These patterns are recognized by the Adapter 195 which can then analyze the patterns and take actions accordingly. The resulting XSD document serves as a control block containing data definitions for all elements to be processed in later processing steps.

XSLTs are either developed by software developers or created using proprietary software tools, such as StylusStudio. Software tools are generally used for mapping from one format of XML into another format of XML.

### Flat File Adapter 240.

To give a more detailed description of the steps performed by the Flat File Adapter 240 component of the Communication Adapter 195, we describe its processing using ffXSD to parse flat files from an ERP system as part of the process of transforming the flat files into XML documents.

From the Communication Adapter's 195 perspective, the problem domain context is: a file contains records; records contain fields; fields contain data. The problem is: records may have relationships with other records in the same file. Records may have relationships with other records in other files. The information may be spread across multiple files that need grouping together to piece together information.

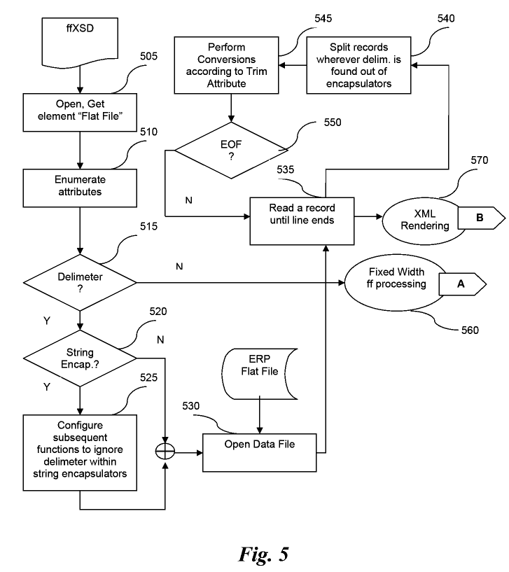

The following is a detailed discussion of the parsing step 302 described earlier. In particular, we discuss a procedure for Flat File Parsing. There are three types of file parsing attributes. They are: File/Record Level, Grouping Level, and Field Level Attributes. Referring now to FIG. 5 there is shown a flowchart illustrating the file parsing attribute of File/Record Level Attributes in the Flat File Adapter 240 using ffXSD. The process begins at step 505 when the Adapter 195 opens the ffXSD document to search for the element name “Flat File.”

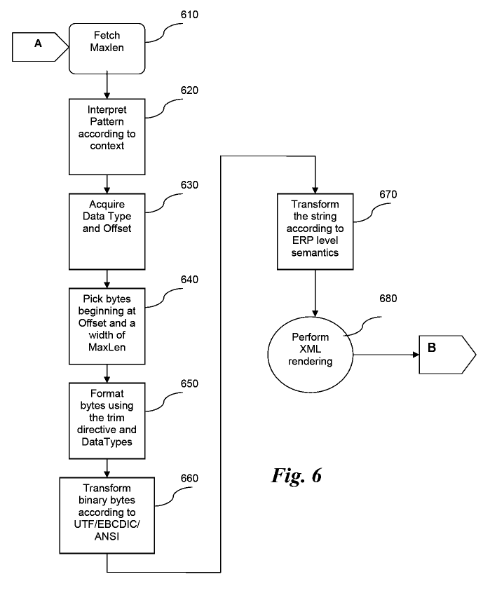

In step 510, all of the flat file's elements' attributes are enumerated and this determines what kind of data file to expect. Attributes can provide a variety of information about a file, not just what type of data file it is. In step 515, if it is determined that the file has a “delimeter” attribute, the data file is presumed to be a set of delimited records where fields are separated by a special “delimeter” character. In this case, the value of the delimeter attribute must be noted for the next parsing steps. If the file contains no delimeter attribute, it is presumed that the file is a fixed width flat file. Then in step 560, fixed width flat file processing proceeds. This is detailed in the discussion related to FIG. 6.

If the file contains a delimeter attribute, then in step 520 a check must be made to determine if the “StringEncapsulator” attribute is specified. If so, the data records in the input file will have string fields that are optionally surrounded by a pair of “StringEncapsulator” characters. In step 525 subsequent functions are performed to ignore the delimeter within the string encapsulators. At this point, processing moves forward to step 530, which is opening the actual data file. Once the data file is opened in step 530, processing continues by reading a record within the data file until the line ends in step 535.

Next, in step 540, the records read are split wherever the delimeter is found outside of the encapsulators. Next, in step 545, if the “Trim” attribute is specified, the processor looks for its default attribute value. If this value is “YES” then all spaces from both ends of strings are stripped. Note that if all of the records have some relationships between them, the field which determines the linkage is stored in the “KeyField” attribute. KeyField contains a “|” separated list of field names. Keep the KeyField collection to trigger a linkage algorithm while continuing to parse the actual data file. For example, assume a node with a segment number of “33.” The linkage algorithm would nest nodes with a parent segment number of “33” as child nodes to the “33” node. In this example, the segment number is what determines the linkage among the nodes.

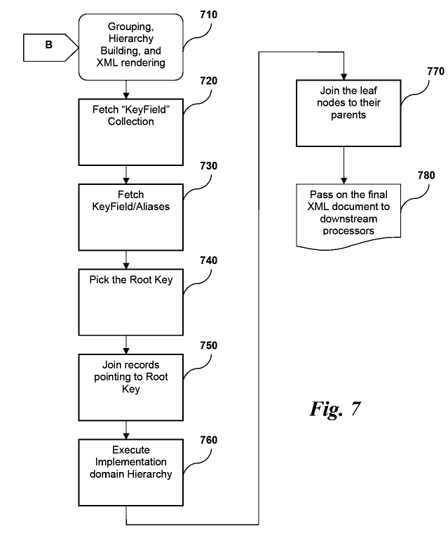

If the KeyField contents that are to be rendered as XML nodes (Elements or Attributes) are not valid XML element names, for example the ones that start with a numeric digit; they cannot be rendered as XML node sets. In that case, processing will continue at step 570 to refer to the KeyFieldAliases list which contains instructions on what XML nodes to create when such keys appear. This part of the XML rendering process discussed with respect to FIG. 7. Note that only a few attributes have been discussed. A flat file may contain other attributes which will be parsed and processed as well.

Referring to FIG. 6 there is shown a flowchart illustrating the process of flat file parsing for field level attributes. This flowchart continues from step 560. Fixed width flat file processing is initiated when a file has no delimeter attributes. The first step, 610, is to retrieve the “MaxLen” (maximum length) attribute. This is the size of the fixed length field. We know that the file is fixed length because it contained no delimeter attribute. The data file is then parsed, starting with the first element. In step 620, the “Pattern” is interpreted by either default or problem domain specific semantics. By default the regular expression “.*” means any character repeated zero or more times; the “( )” indicates pick up a group within these parentheses; the character “*” right after the parentheses indicates that this pattern would repeat zero or more times (note that this is the standard regular expression).

In step 630 the data type and offset are acquired. Within the parentheses there is a pair of tokens separated by a “|” character. This is a separator, which concatenates data type with the starting point of a field (or byte offset). In step 640 the cursor is placed at the byte position picked up from step 630, and the MaxLen characters are selected. In step 640 the bytes are formatted according to the data type obtained from the previous step.

In step 650 a specialized conversion is performed on the field values picked up from the preceding step. The object may raise special events subscribed by its user; it may even raise non-conformance exceptions according to the destination implementation domain (e.g. EDI) semantics. In step 660 XML nodes are created from the file records, according to the implementation domain needs and/or downstream component specifications. Lastly, in step 670 the XML nodes are passed to the invoking grouping logic in step 680, as described with respect to FIG. 7.

Referring to FIG. 7 there is shown a flowchart illustrating the process of flat file parsing for grouping/XML rendering. This flowchart is a continuation of step 680 in FIG. 6 and step 570 in FIG. 5. The first step 710 is a compound step of Grouping, Hierarchy Building, and XML rendering. This means that attributes are grouped for the outbound file. Then, depending upon the ERP requirements described in the XSD patterns is how the data in the files is to be grouped. The XML data will be rendered accordingly. Also at this point a hierarchy of records is developed, such as “line items” within a purchase order and purchase orders within an envelope.

Next, in step 720 the KeyField collection is fetched; it contains an orderly sequence of keys for parent-child node relationships. The first one will become the root node, representing a flat file header record; others would be the detail nodes. In step 730 the KeyField Aliases are fetched. You will recall that the KeyField Aliases list contains instructions on what XML nodes to create when non-compatible keys appear.

Next in step 740 the root key is selected from the KeyField collection. This is important in any hierarchical representation. Step 750 joins records pointing to the root key. The implementation of the domain hierarchy is executed in step 760. This step involves selecting a root node and selecting the records pointing to that root node; and identifying parent and child nodes. Step 770 joins the leaf nodes to their parents. Finally, in step 780, the finalized XML document is passed on to downstream processors.

Referring to FIG. 14 there is shown a flowchart of the process steps for transforming an XML document into a non-XML (flat file) document. The process begins at step 1410 where the XML document is received as input. In an offline process, in step 1470 an ffXSD document is created from this input document by defining the XML elements. Then in step 1472, the ffXSD output from step 1470 is used to create an XSLT document. A further input into this step is the end user's business process which is a written specification.

Concurrently with the offline process, in step 1420 the XML document is parsed. Then in step 1430 the XML nodes from the XML document are mapped to records and fields. In step 1440 the conversion is performed. This involves translating the ffXSD constraints into flat file attributes and converting the XML nodes to records.

Once the document is converted, the flat file output is transmitted to the end user in step 1450. Also, the flat file is converted to HTML so that is viewable by a web browser. Optionally, the end user may be billed for each transmission or may subscribe for a monthly service. In order to facilitate the billing process, each transmission must be logged and a cost allocated.

### Transformation Processing Sample.

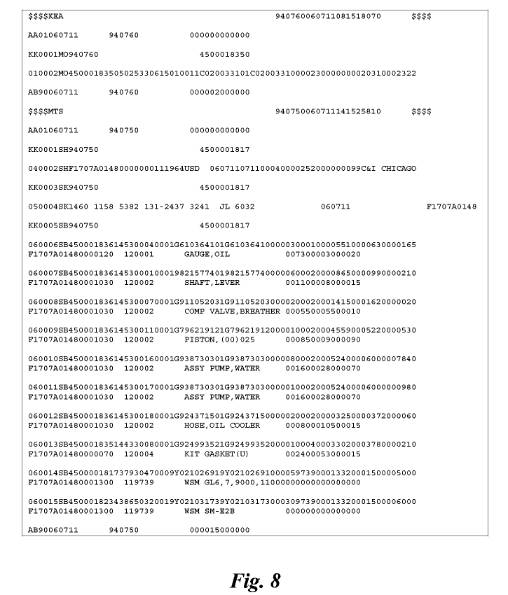

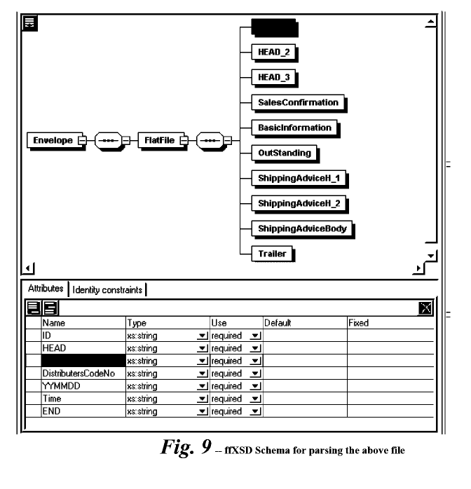

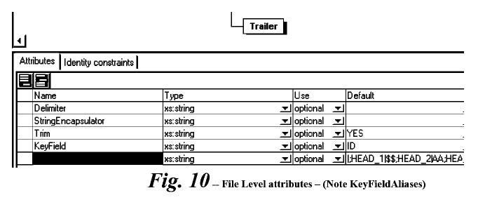

Referring now to FIG. 8 there is shown a sample of a raw input file in flat file format. FIG. 9 shows the ffXSD schema for parsing the input file. FIG. 10 shows the file level attributes. Note the KeyFieldAliases field. KeyFieldAliases is the area in ffXSD where file and record level patterns are stored. This is where the specialized patterns described earlier are inserted.

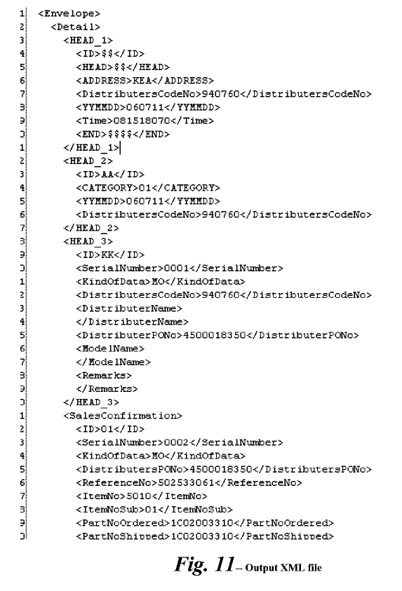

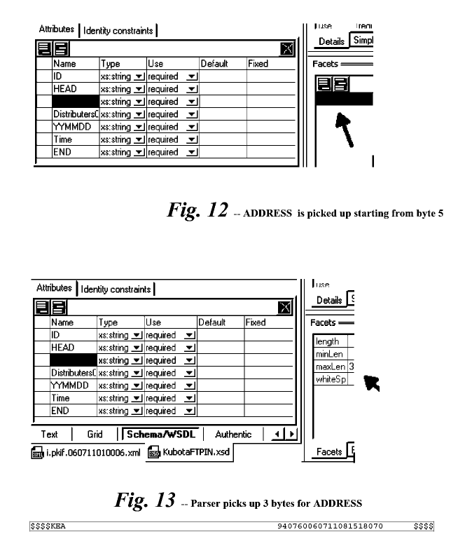

FIG. 11 shows the resultant output XML file. FIG. 12 shows how the ADDRESS field is parsed according to the field level attributes. FIG. 13 shows more detailed field information for the ADDRESS field, specifying that it has a maximum length of three characters. The Length field does not have any special patterns; but note that FIG. 12 shows the application of the special pattern ‘.*(AN|5)*’ to the ADDRESS field. This illustrates the key feature of O-XML: the applying of specialized patterns for extending XSD to work with flat files. Normally XML does not work with data position but in flat files data positioning must be specified. This is an example where the application of the special patterns allows XML to work with a non-XML constraint to satisfy flat file requirements.

The XML below displays the output:

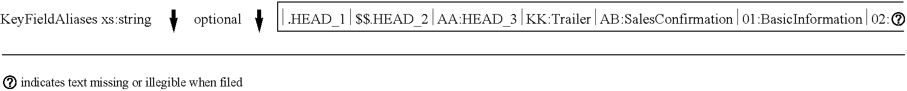

Comparing this with FIGS. 12 and 13, one can see that the XML elements (ID, HEAD, ADDRESS, . . . ) are in the same sequence as the ffXSD attributes. The KeyFieldAliases attribute instructs the Adapter 195 to generate HEAD_1 record element if the key field contents are $$. FIG. 10 displays the KeyField attribute as ID. Therefore the flat file record line beginning with $$$$KEA is recognized as a record named HEAD_1, and all fields of this record are enclosed within this element, as shown below:

```
<HEAD_1>
  <ID>$$</ID>
  <HEAD>$$</HEAD>
  <ADDRESS>KEA</ADDRESS>
  <DistributersCodeNo>940760</DistributersCodeNo>
  <YYMMDD>060711</YYMMDD>
  <Time>081518070</Time>
  <END>$$$$</END>
  </HEAD_1>
```

### O-XML Product Features:

O-XML uses a forms-based authentication mechanism to make sure that only authenticated users have access to any part of the application. Access to the documents is segregated based on the registered organization to which each user belongs.

### Communication.

The O-XML Adapter 195, with the optional components, is able to support, but is not limited to, the following modes of communication: FTP, SFTP, FTPS, AS1, AS2, Web Services, PGP over FTP, and communication queuing. Some of the file formats that are supported are: XML, X12 EDI, EDIFACT, Flat Files, CSV, Excel, EBCDIC, and HIPAA.

ERP Integration. The O-XML Adapter 195, with optional components, supports the following ERP software: SAP, PeopleSoft, JD Edwards, Great Plains, and others. In fact, O-XML can be integrated with an ERP system, via a connector. If a connector doesn't exist for a given ERP, it can be developed.

Translator Features. O-XML features support for replacing and/or complementing IBM mainframe-based EDI translators. O-XML can replace existing AS/400, (iSeries), etc. translators. Additionally, it can create and consume file for the mentioned midrange systems. Complex data mapping support: O-XML supports the use of complex data mappings between document types, which includes mathematical computations, text transformations, and business logic integration.

Interface. Rich Desktop Client: The application runs as a native application on the clients' desktop. Web Portal: the complete web application is hosted on servers at a central location.

Real-Time Background Processing: Document Processing is triggered by its receipt. As soon as a transaction comes in, it is automatically queued for processing. This considerably reduces the turnaround time for document processing over polling based methods.

Batch Processing: The translator is scriptable and can be kicked off from a client created batch process.

Enterprise Application Integration (EAI): The application supports integration of the EDI/XML transactions into the customer's individual supply chain. This is done through the use of customized Enterprise Application Integration adapters.

Thin Client: The application is hosted entirely on the server side, allowing for client machines to be set up with minimal efforts. In most cases, the client machine will just need a HTML 4.0 or higher compatible browser with reasonable Cascading Style Sheets (CSS) support (Microsoft©) Internet Explorer, Netscape Navigator, Mozilla Firefox, Safari, Opera etc.).

Therefore, while there has been described what is presently considered to be the preferred embodiment, it will understood by those skilled in the art that other modifications can be made within the spirit of the invention.

We claim:

1. A method for transforming at least one non-XML file into an XML file, the method comprising steps of:
receiving the at least one non-XML file as input, wherein the at least one non-XML file comprises fields, records, and file attributes;
creating an ffXSD document from the at least one non-XML file using an ffXSD process;
creating an XSLT document from the ffXSD document using a user's business process;
parsing the at least one non-XML file for producing at least one parsed non-XML file;
mapping the records and fields of the at least one non-XML file to XML nodes;
converting the at least one parsed non-XML file into an XML source file, using ffXSD; and
converting the XML source file to the XML file by applying XML tags from XSLT to the XML source file, and using the ffXSD process, such that the XML file corresponds to the user's business process and the XML file is viewable via a web browser.

2. The method of claim further comprising a step of:
transmitting the XML file to the user.

3. The method of claim 2 wherein the transmitting step further comprises transmitting the XML file to a web server.

4. The method of claim 2 wherein the transmitting step further comprises transmitting the XML file to a downstream processor.

5. The method of claim 1 further comprising steps of:
allocating a cost to each instance of transmitting the XML file; and
billing the user for the allocated cost.

6. The method of claim 1 wherein the creating steps are performed offline.

7. The method of claim 1 wherein the parsing step comprises steps of:
enumerating file attributes;
performing fixed width flat file processing if the at least one non-XML file comprises at least one delimeter;
configuring subsequent functions to ignore the at least one delimeter within string encapsulators if the at least one non-XML file comprises at least one string encapsulator;
opening a data file associated with the at least one non-XML file; and
reading data file records until end of file, the reading step comprising splitting records wherever the at least one delimeter is found outside of the at least one string encapsulator and performing conversions according to trim attributes.

8. The method of claim 1 wherein creating the ffXSD document comprises steps of:
converting the records into tagged XML nodes; and
applying specialized patterns to non-XML attributes contained within the at least one non-XML file, said specialized patterns recognizable as XSD constraints.

9. The method of claim 8, wherein the applying step comprises:
inserting the specialized patterns into at least one existing pattern constraint within the XSD.

10. The method of claim 9 wherein the at least one existing pattern constraint is xs:pattern.

11. The method of claim 1 wherein converting the at least one non-XML file using ffXSD comprises steps of:
analyzing flat file record definition patterns in XSD;
converting the records and fields to XML nodes according to patterns from the ffXSD process; and
interpreting the specialized patterns as XSD constraints such that XML elements are in a same sequence as their corresponding ffXSD attributes.

12. The method of claim 11 further comprising steps of:
retrieving a keyfield collection comprising a sequence of keys denoting relationships among the XML nodes for executing a linkage process;
retrieving a keyfield aliases list comprising file and record level patterns, and instructions on mapping non-compatible keys to XML nodes; and
implementing a domain hierarchy, comprising steps of selecting a root node; joining records pointing to the root node; and joining leaf nodes to parent nodes.

13. The method of claim 1 wherein the receiving step further comprises filtering requests such that only valid requests are handled, wherein the requests comprise the at least one non-XML file.

14. The method of claim 1 wherein the at least one non-XML file is a flat file.

15. The method of claim 7, wherein:
the at least one string encapsulator indicates that the records in the data file comprise string fields that are surrounded by a pair of string encapsulator characters;
the delimeter indicates that the data file comprises a set of delimeted records where fields are separated by a delimeter character; and
the trim attribute indicates that spaces are to be stripped from both ends of data strings in the data file.

16. The method of claim 1 wherein the receiving step further comprises receiving the input as part of a client-created batch process, wherein receipt of this batch process initiates execution of the transforming steps.

17. A method for transforming an XML file into at least one non-XML file, the method comprising steps of:
receiving the XML file as input, wherein the XML file comprises a plurality of XML nodes;
creating an ffXSD document from the XML file by defining XML elements;
creating an XSLT document from the ffXSD document using a user's business process;
parsing the XML file;
mapping the XML nodes to records and fields; and
converting the XML document into the at least one non-XML file, the converting step comprising: translating ffXSD constraints to flat file attributes; and converting the XML nodes to records.

18. The method of claim 17 further comprising a step of:
transmitting the at least one non-XML file to a user.

19. The method of claim 18 further comprising steps of:
allocating a cost to each instance of transmitting the at least one non-XML file; and
billing the user for the allocated cost.

20. The method of claim 17 wherein the creating steps are performed offline.

21. The method of claim 17 wherein the receiving step further comprises filtering requests such that only valid requests are handled, wherein the requests comprise the XML file.

22. A system for transforming an input file in a first format into an output document in a second format, the system comprising:
a communication adapter for translating an XML source file into the output document;
a network access translation firewall;
a load balancer;
an offline processor for creating ffXSD and XSLT documents; and
an input/output subsystem for interacting with a user, the subsystem comprising a network interface.

23. The system of claim 22 wherein the communication adapter is a representation of various adapters and comprises two main components:
a flat file adapter; and
an XML adapter.

24. The system of claim 22 wherein the communication adapter is hosted at a central location.

25. The system of claim 22 wherein the communication adapter is hosted at a client site.

26. The system of claim 22 wherein the load balancer is a front-end reverse proxy load balancer.

27. The system of claim 22 wherein the first format is a format selected from a group consisting of: an XML file and a non-XML file.

28. The system of claim 22 wherein the communication adapter is at least one software script.
